(19) United States
(12) Patent Application Publication
(10) Pub. No.: US 2022/0239228 A1
(43) Pub. Date: Jul. 28, 2022

(54) CONTROL CIRCUIT AND CONTROL METHOD OF DC/DC CONVERTER, POWER MANAGEMENT CIRCUIT

(71) Applicant: ROHM CO., LTD., Kyoto-Shi (JP)

(72) Inventor: Shun FUKUSHIMA, Kyoto-Shi (JP)

(21) Appl. No.: 17/581,548

(22) Filed: Jan. 21, 2022

(30) Foreign Application Priority Data
Jan. 25, 2021 (JP) 2021-009707
Oct. 22, 2021 (JP) 2021-173360

(51) Int. Cl. H02M 3/158; H02M 1/08

(52) U.S. Cl. CPC H02M 3/1588; H02M 1/14; H02M 1/083

(57) ABSTRACT

The disclosure relates to a control circuit and control method of a DC/DC converter, and a power management circuit. A control circuit of a DC/DC converter with a stable switching frequency is provided. An on-time generating circuit asserts a turn-off signal after an on time has elapsed from turning-on of a switching transistor. A charging circuit charges a capacitor with a charging current corresponding to an input voltage of the DC/DC converter. A frequency stabilizing circuit generates a control signal such that a switching frequency of the switching transistor approximates a reference frequency. A second comparator compares a slope voltage generated in the capacitor with the threshold voltage corresponding to the control signal, and generates the turn-off signal according to a comparison result.

### CROSS REFERENCE TO RELATED APPLICATIONS

The present invention claims priority under 35 U.S.C. § 119 to Japanese Application No. 2021-009707 filed Jan. 25, 2021, and Japanese Application No. 2021-173360 filed Oct. 22, 2021, the entire content of which is incorporated herein by reference.

### TECHNICAL FIELD

The disclosure relates to a direct-current (DC)/DC converter.

### BACKGROUND

A direct-current (DC)/DC converter is used to convert a DC voltage in a certain voltage value to a DC voltage in another voltage value. A ripple control means is available as a control means for a DC/DC converter. In the ripple control means, an output voltage of a DC/DC converter is compared with a threshold voltage, and if the output voltage exceeds (or is below) the threshold voltage, it is used to trigger turning on and off of a switching transistor. Compared to a voltage mode control means or a current mode control means using an error amplifier, the ripple control means features advantages of having a high response speed and reduced power consumption. An advantage of reducing capacitance of an output capacitor of the DC/DC converter is further provided.

### PRIOR ART DOCUMENT

### Patent Publication

[Patent document 1] Japan Patent Publication No. 2017-169259

### SUMMARY

### Problems to be Solved by the Disclosure

Peak detection/constant on time (COT) control is available as one ripple control means. In COT control, due to a fluctuating switching frequency, applications involving direct use thereof may be challenging from the perspective of electromagnetic interference (EMI).

The disclosure is completed in view of the problem above. It is an illustrative object of one aspect of the disclosure to provide a control circuit of a DC/DC converter with a stable switching frequency.

### Technical Means for Solving the Problem

An aspect of the disclosure relates to a control circuit of a DC/DC converter. The control circuit is a control circuit of a DC/DC converter including a switching transistor, and includes: a first comparator comparing a feedback voltage corresponding to an output voltage of the DC/DC converter with a reference voltage to assert a turn-on signal when the feedback voltage falls below the reference voltage; an on-time generating circuit asserting a turn-off signal after an on time has elapsed from a turning on of the switching transistor; a logic circuit generating a pulse signal based on the turn-on signal and the turn-off signal; and a driver driving the switching transistor according to the pulse signal. The on-time generating circuit includes: a capacitor; a charging circuit charging the capacitor with a charging current corresponding to an input voltage of the DC/DC converter; a frequency stabilizing circuit generating a control signal such that a switching frequency of the switching transistor approximates a reference frequency; a threshold voltage generating circuit generating a threshold voltage corresponding to the control signal; and a second comparator comparing a slope voltage generated in the capacitor with the threshold voltage and generating the turn-off signal according to a comparison result.

Another aspect of the disclosure relates to a control method of a DC/DC converter. The control method is a control method of a DC/DC converter including a switching transistor, the method including: comparing a feedback voltage corresponding to an output voltage of the DC/DC converter with a reference voltage, and asserting a turn-on signal when the feedback voltage falls below the reference voltage; asserting a turn-off signal after an on time has elapsed since the switching transistor was turned on; generating a pulse signal based on the turn-on signal and the turn-off signal; and driving the switching transistor according to the pulse signal. The step of asserting the turn-off signal includes: charging a capacitor with a charging current corresponding to an input voltage of the DC/DC converter; generating a control signal such that a switching frequency of the switching transistor approximates a reference frequency; comparing a slope voltage generated in the capacitor with the threshold voltage corresponding to the control signal; and generating the turn-off signal according to a comparison result.

Moreover, all materials obtained from any combination of the constituting elements above, and all materials obtained from mutual substitutions of the constituting elements of the disclosure or expressed in forms of methods, devices and systems are considered as effective embodiments of the disclosure.

### Effects of the Disclosure

According to an aspect of the disclosure, a stable frequency can be achieved.

### BRIEF DESCRIPTION OF THE DRAWINGS

FIG. 1 is a circuit diagram of a DC/DC converter according to an embodiment.

FIG. 2 is a waveform diagram of the operation of the DC/DC converter in FIG. 1.

FIG. 3 is a circuit diagram of a DC/DC converter of a comparison technique.

FIG. 4 is a waveform diagram of the operation of the DC/DC converter in FIG. 3.

FIG. 5 is a waveform diagram of the operation of the DC/DC converter according to an embodiment.

FIG. 6 is a circuit diagram of a configuration example of a frequency stabilizing circuit.

FIG. 7 is a circuit diagram of a configuration example of a charging circuit.

FIG. 8 is a circuit diagram of a configuration example of a threshold voltage generating circuit.

FIG. 9 is a circuit diagram of a DC/DC converter corresponding to a discontinuous current mode (DCM).

FIG. 10 is a diagram for illustrating a continuous current mode (CCM), a DCM and a switching operation in a control circuit.

FIG. 11 is a waveform diagram of the operation of the control circuit with inhibited inter-mode oscillation.

FIG. 12 is a circuit diagram of a threshold voltage generating circuit.

FIG. 13 is a diagram of a waveform of an output voltage in the DCM.

FIG. 14 is a diagram for illustrating transition from a DCM to CCM in a second switching method.

FIG. 15 is a diagram for illustrating transition from a CCM to a DCM in the second switching method.

FIG. 16 is a circuit diagram of a DC/DC converter corresponding to the second switching method.

FIG. 17 is a block diagram of a logic circuit corresponding to the second switching method.

FIG. 18 is a waveform diagram of the operation of the logic circuit in FIG. 17 transitioning from a DCM to a CCM.

FIG. 19 is a waveform diagram of the operation of the logic circuit in FIG. 17 transitioning from a CCM to DCM.

FIG. 20 is a circuit diagram of a part of an on-time generating circuit of a first variation example.

FIG. 21 is a diagram of a slope voltage generated in the on-time generating circuit in FIG. 20.

FIG. 22 is a block diagram of a system with power management.

### DETAILED DESCRIPTION

### Summary of Embodiments

A summary of several exemplary embodiments of the disclosure is given below. The summary serves as the preamble of the detailed description to be given shortly, and aims to provide fundamental understanding of the embodiments by describing several concepts of one or more embodiments in brief. It should be noted that the summary is not to be construed as limitations to the scope of the disclosure. Moreover, the summary does not necessarily encompass all conceivable and possible embodiments, and does provide specific definitions for essential constituent elements of the embodiments. For the sake of better description, “one embodiment” sometimes refers to one embodiment (implementation example or variation example) or multiple embodiments (implementation examples or variation examples).

In one embodiment, a control circuit of a direct-current (DC)/DC converter including a switching transistor includes: a first comparator comparing a feedback voltage corresponding to an output voltage of the DC/DC converter with a reference voltage to assert a turn-on signal when the feedback voltage falls below the reference voltage; an on-time generating circuit, asserting a turn-off signal after an on time has elapsed from a turning on of the switching transistor; a logic circuit generating a pulse signal based on the turn-on signal and the turn-off signal; and a driver driving the switching transistor according to the pulse signal. The on-time generating circuit includes: a capacitor; a charging circuit for charging the capacitor with a charging current corresponding to an input voltage of the DC/DC converter; a frequency stabilizing circuit for generating a control signal such that a switching frequency of the switching transistor approximates a reference frequency; a threshold voltage generating circuit for generating a threshold voltage corresponding to the control signal; and a second comparator for comparing a slope voltage generated in the capacitor with the threshold voltage and generating the turn-off signal according to a comparison result.

According to the configuration above, for a fluctuating input voltage, an on time is adjusted by feedforward control that changes a charging speed of the capacitor, thereby achieving a stable frequency. Moreover, in parallel, regarding factors such as a fluctuating input voltage or a fluctuating load, an on time is adjusted by adjusting feedback control of a threshold voltage, thereby achieving a stable frequency. With a combination of the feedforward control and the feedback control, the stable switching frequency in COT control is achieved.

In one embodiment, the threshold voltage generating circuit may generate the threshold voltage by shifting a voltage difference corresponding to the control signal by means of a voltage proportional to the output voltage of the DC/DC converter as a reference. Accordingly, the threshold voltage is generated by means of using a voltage proportional to the output voltage of the DC/DC converter as a reference, and feedforward control is performed on the output voltage. Thus, the on time can be optimized even in a discontinuous current mode (DCM) in which a control frequency cannot be fed back.

In one embodiment, the frequency stabilizing circuit includes: a voltage dividing circuit for dividing the output voltage of the DC/DC converter; and a current source connected to an output node of the voltage dividing circuit and generating a current corresponding to the control signal, wherein a voltage generated at the output node of the voltage dividing circuit is the threshold voltage. Accordingly, the threshold voltage can be changed based on the voltage when the current generated by the current source is zero.

In one embodiment, the current source is a gm amplifier that generates a current corresponding to a difference between the control signal and a predetermined voltage.

In one embodiment, the charging circuit includes a variable current source that produces a current proportional to the input voltage.

In one embodiment, the charging circuit may include a resistor including a first end that receives the input voltage and a second end that is connected to the capacitor. Accordingly, compared to a situation where a variable current source is used, the circuit configuration can be simplified.

In one embodiment, the frequency stabilizing circuit is disabled when the DC/DC converter operates in a discontinuous current mode. In one embodiment, when the DC/DC converter operates in a discontinuous current mode, a current of the current source may be zero.

In one embodiment, when the DC/DC converter transitions from a continuous current mode to a discontinuous current mode, the frequency stabilizing circuit is invalid provided that a length of a high impedance period exceeds a predetermined period. Accordingly, the ripple current can be reduced.

In one embodiment, when the reference frequency is f_{REF}, the input voltage of the DC/DC converter is V_{IN}, and the output voltage is V_{OUT}, an on time T_{ON_DCM} in the on-time generating circuit when the DC/DC converter operates in a discontinuous current mode may satisfy:

T_{ON_DCM}>1/f_{REF}*V_{OUT}/V_{IN}.

Accordingly, inter-mode oscillation occurring back and forth between the continuous current mode and the discontinuous current mode can be inhibited.

In one embodiment, a voltage dividing ratio of the voltage dividing circuit is greater when the DC/DC converter operates in a discontinuous current mode than in a continuous current mode. Accordingly, inter-mode oscillation occurring back and forth between the continuous current mode and the discontinuous current mode can be inhibited.

In one embodiment, the control circuit may also be integrated in a semiconductor substrate. The so-called “integrated” includes a situation in which all constituting elements of a circuit are formed on a semiconductor substrate, or a situation in which main constituting elements of a circuit are integrated. In order to adjust circuit constants, a part of resistors or capacitors may be arranged outside the semiconductor substrate. By integrating circuits on one chip, the circuit area is reduced and characteristics of circuit elements are kept uniform.

### Embodiments

Details of the preferred embodiments of the disclosure are specifically given with the accompanying drawings below. The same or equivalent constituting elements, parts and processes are represented by the same denotations, and repeated description is omitted as appropriate. It should be noted that the embodiments are non-limiting examples of the disclosure, and all features or combinations thereof described in the embodiments are not necessarily essentials of the disclosure.

In the description of the application, an expression “a state of component A connected to component B” includes, in addition to a situation where component A and component B are directly connected, a situation where component A is indirectly connected to component B via another component, and the indirect connection does not result in substantial influences on their electrical connection or does not impair functions or effects exerted by their connection.

Similarly, an expression “a state of component C arranged between component A connected to component B” includes, in addition to a situation where component A and component B, or component B and component C are directly connected, an indirect connection via another component, and the indirect connection does not result in substantial influences on their electrical connection or does not impair functions or effects exerted by their connection.

Moreover, the so-called “signal A (voltage or current) corresponds to signal B (voltage or current) means that signal A is associated with signal B, and specifically means that (i) signal A is signal B, (ii) signal A is proportional to signal B, (iii) signal A is obtained by shifting the level of signal B, (iv) signal A is obtained by amplifying signal B, (v) signal A is obtained by inverting signal B, and (vi) any combination of the above. It should be understood that the range of “according to” is determined according to the types and use of signals A and B.

The vertical axis and horizontal axis in the waveform diagrams or timing diagrams referenced in the disclosure are appropriately scaled up or scaled down for better understanding, and the waveforms are also simplified, exaggerated or emphasized for better understanding.

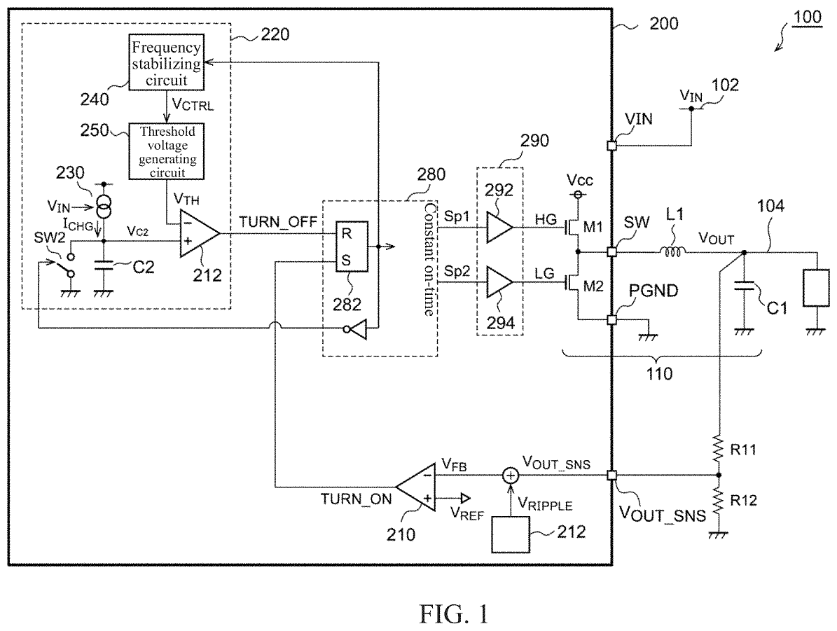

FIG. 1 shows a circuit diagram of a DC/DC converter 100 according to an embodiment. The DC/DC converter 100 is a buck converter, which stabilizes an input voltage V_{IN} of an input line (input terminal) 102 to a predetermined voltage level, and supplies the same to a load 4 connected to an output line (output terminal) 104.

The DC/DC converter 100 includes a main circuit (output circuit) 110 and a control circuit 200. The main circuit 110 includes an inductor L1, a switching transistor (high-side transistor) M1, a synchronous rectifier transistor (low-side transistor) M2, and an output capacitor C1.

The control circuit 200 is a controller that controls the main circuit 110 by a ripple control means, more specifically, by means of peak detection, such that an output voltage V_{OUT} approximates a target voltage. The control circuit 200 is a function integrated circuit (C) integrated in a semiconductor substrate, and has an input pin (pin VIN), a switch pin (PIN SW), a ground pin (pin PGND), and a voltage sensing pin (pin VOUT_SNS). The pin VIN is connected to the input line 102, the pin SW is connected to an externally provided inductor L1, and the pin PGDN is grounded. The pin VOUT_SNS is connected to a voltage dividing circuit including resistors R11 and R12, and is fed back with a voltage V_{OUT_SNS} divided from the output voltage V_{OUT}.

V_{OUT_SNS}=V_{OUT}*R12/(R11+R12) (1)

The switching transistor M1 and the synchronous rectifier transistor M2 in the main circuit 110 are integrated in the control circuit 200, the switching transistor M1 is disposed between the pin VIN and the pin SW, and the synchronous rectifier transistor M2 is disposed between the pin SW and the pin PGND.

In addition to the switching transistor M1 and the synchronous rectifier transistor M2, the control circuit 200 further includes a first comparator 210, an on-time generating circuit 200, a logic circuit 280 and a driver 290.

A first comparator 210 compares a feedback voltage V_{FB} corresponding to the output voltage V_{OUT} of the DC/DC converter 100 with a reference voltage V_{REF} to assert a turn-on signal TURN_ON when the feedback voltage V_{FB} falls below the reference voltage V_{REF}. The turn-on signal TURN_ON is a pulse signal representing a size relationship between V_{FB} and V_{REF}, and can be asserted correspondingly to one between a positive edge and a negative edge. When the feedback voltage V_{FB} falls below the reference voltage V_{REF}, that is, when the output voltage V_{OUT} falls to a target voltage V_{OUT}(REF), the turn-on signal TURN_ON is asserted. The target voltage V_{OUT(REF)} is expressed as an equation below.

V_{OUT(REF)}=V_{REF}*(R11+R12)/R12 (2)

A ripple superimposing circuit 212 may also be disposed at a front end of the first comparator 210. The ripple superimposing circuit 212 superimposes a ripple voltage V_{RIPPLE} on a voltage of the pin V_{OUT_SNS} to generate the feedback voltage VFW

The on-time generating circuit 220 asserts a turn-off signal TURN_OFF after an on time TON has elapsed from the turning on of the switching transistor M1. The on time T_{ON} is adaptively controlled according to the state of the DC/DC converter 100, as described below. The turn-off signal TURN_OFF is triggered by the turning off of the switching transistor M1.

The logic circuit 280 generates a pulse signal (to be referred to as a signal COT below) based on the turn-on signal TURN_ON and the turn-off signal TURN_OFF, and generates a high-side pulse Sp1 and a low-side pulse Sp2 based on the signal COT. For example, the logic circuit 280 includes an SR flip-flop 282 that is set according to the turn-on signal TURN_ON and reset according to the turn-off signal TURN_OFF; alternatively, an output of the SR flip-flop 282 may also be used as the signal COT. The configuration of the logic circuit 280 is not specifically defined, and any commonly known technique may be used.

The driver 290 includes a high-side driver 292 that drives the switching transistor M1 according to the high-side pulse Sp1, and a low-side driver 294 that drives the synchronous rectifier transistor M2 according to the low-side pulse Sp2.

The on-time generating circuit 220 includes a capacitor C2, a charging circuit 230, a frequency stabilizing circuit 240, a threshold voltage generating circuit 250 and a second comparator 260.

A first end of the capacitor C2 is grounded. The charging circuit 230 is connected to a second end of the capacitor C2, and charges the capacitor C2 by a charging current I_{CHG}=α*V_{IN} proportional to the input voltage V_{INT} of the DC/DC converter 100. α is a voltage/current (V/I) conversion gain (transconductance).

In the capacitor C2, a slope voltage (ramp voltage) V_{C2} that increases by a fixed slope along with time is generated. A discharging switch SW2 is connected in parallel to the capacitor C2. The discharging switch SW2 is turned on in an off period and is turned off in an on period of the switching transistor M1. A control signal of the discharging switch SW2 may also be an inverted signal of the signal COT.

The frequency stabilizing circuit 240 generates a control signal V_{CTRL} such that a switching frequency f_{SW} of the switching transistor M1 approximates a reference frequency f_{REF}. For example, the frequency stabilizing circuit 240 monitors the signal COT or the high-side pulse SP1 or the low-side pulse SP2 based on the signal COT to generate the control signal V_{CTRL} by means of feedback, such that the frequency (switching cycle) of a monitored target approximates a reference frequency (reference cycle).

The threshold voltage generating circuit 250 generates a threshold voltage V_{TH} corresponding to the control signal V_{CTRL}.

The second comparator 260 compares a slope voltage V_{C2} generated in the capacitor C2 with the threshold voltage V_{TH}, and generates the turn-off signal TURN_OFF according to a comparison result. The turn-off signal TURN_OFF is asserted when the slope voltage V_{C2} reaches the threshold voltage V_{TH}. A period from when the turn-on signal TURN_ON is asserted to when the turn-off signal TURN_OFF is asserted becomes an on time T_{ON} of the switching transistor M1.

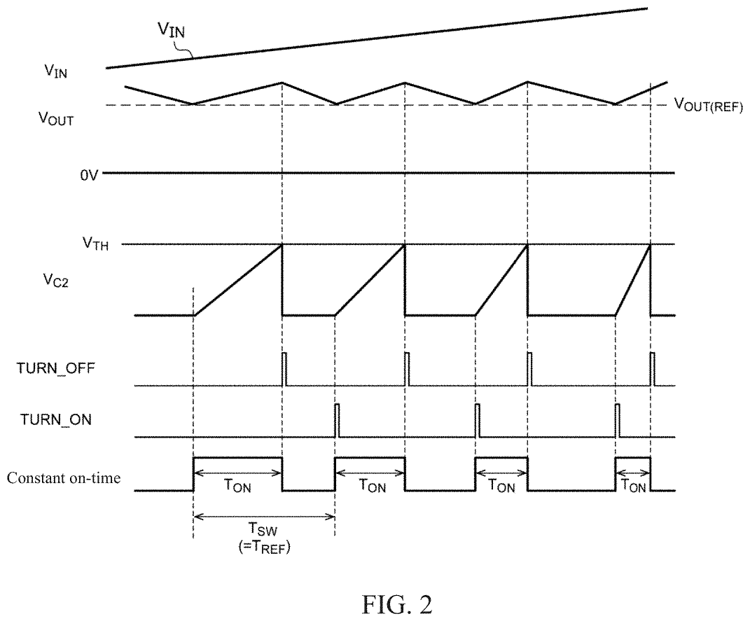

The fundamental configuration of the DC/DC converter 100 is as described above. The operation of the DC/DC converter 100 is to be described below. FIG. 2 shows a waveform diagram of the operation of the DC/DC converter 100 in FIG. 1. A situation where a load current I_{OUT} is constant but the input voltage V_{IN} fluctuates is considered.

The output voltage V_{OUT} is linked with the switching of the DC/DC converter 100, and repeatedly rises and drops. When the output voltage V_{OUT} drops to the target voltage V_{OUT}(REF), the turn-on signal TURN_ON is asserted, and signal COT transitions to be at an on level, the switching transistor M1 is turned on, and the synchronous rectifier transistor M2 is turned off.

When the signal COT transitions to be at an on level, the on-time generating circuit 220 triggered accordingly starts operating. Specifically, when the signal COT transitions to be at an on level, the discharging switching SW2 is turned off, and the slope voltage V_{C2} of the capacitor C2 charged by the charging circuit 230 increases with time. Moreover, the turn-off signal TURN_OFF is asserted when the slope voltage V_{C2} reaches the threshold voltage V_{TH} generated by the threshold voltage generating circuit 250.

The DC/DC converter 100 repeats the process above.

Since the charging current I_{CHG} generated by the charging circuit 230 is proportional to the input voltage V_{IN}, a slope of the slope voltage V_{C2} steepens as the input voltage V_{IN} increases. Thus, the on time T_{ON} is inversely proportional to the input voltage V_{IN}, as shown in equation (3).

$$\begin{matrix}{T}_{ON} = ( C 2 * {V}_{TH} ) / {I}_{CHG} \\ = ( C 2 * {V}_{TH} ) / ( α * {V}_{IN} ) \\ = β \cdot {V}_{TH} / {V}_{IN}\end{matrix} \\ β = C 2 / α \qquad ( 3 )$$

Herein, in a normal state, equation (4) below is established for a duty cycle d of a buck converter, the input voltage V_{IN} and the output voltage V_{OUT}.

V_{OUT}=V_{IN}*d=V_{IN}*T_{ON}/T_{SW} (4)

By substituting equation (3) into equation (4), equation (5) is obtained.

V_{OUT}=V_{IN}*(β·V_{TH}/V_{IN})/T_{SW}=β·V_{TH}/T_{SW} (5)

Herein, with feedback control performed by the frequency stabilizing circuit 240, the switching cycle T_{SW} is stabilized to a reference cycle T_{REF} (=1/f_{REF}), which may be regarded as a constant. That is to say, according to the embodiment above, the switching frequency f_{SW} can be kept constant, and the output voltage V_{OUT} can be stabilized to a voltage level corresponding to the threshold V_{TH} regardless of how the input voltage V_{IN} fluctuates.

The advantages of the DC/DC converter 100 of the embodiment becomes apparent with respect to a comparison technique.

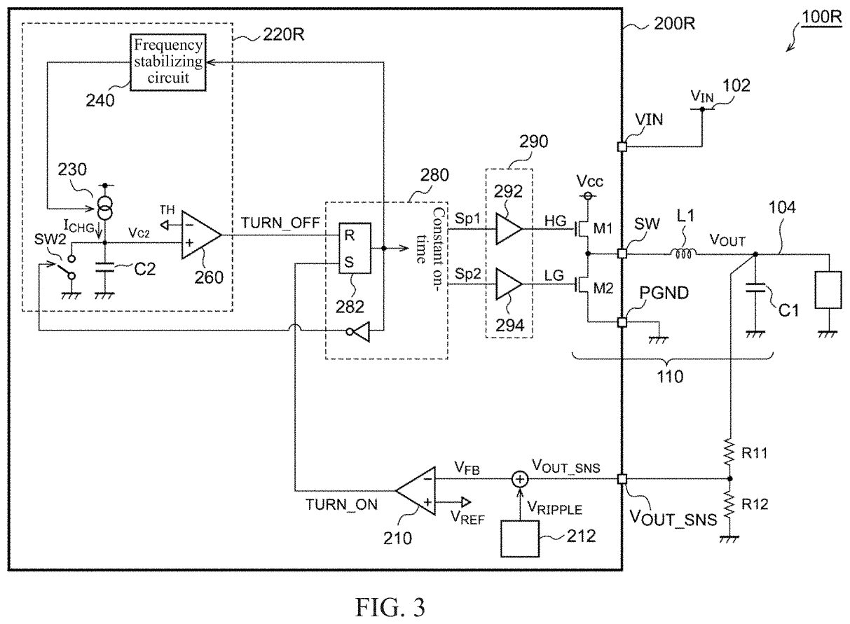

FIG. 3 shows a circuit diagram of a DC/DC converter 100 of the comparison technique. In the on-time generating circuit 220, the current Imo generated by the charging circuit 230 changes according to the control signal V_{CTRL} generated by the frequency stabilizing circuit 240. That is to say, the on time T_{ON} is adjusted by feedback control on the slope of the slope voltage V_{C2} of the capacitor C2, thereby stabilizing the switching frequency.

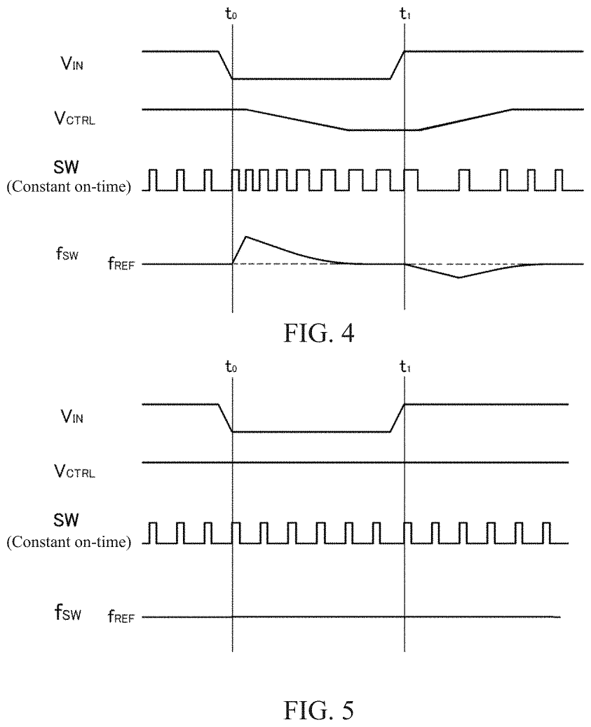

FIG. 4 shows a waveform diagram of the operation of the DC/DC converter 100R in FIG. 3. Before a timing to, the input voltage V_{IN} is stabilized at a voltage level, and the frequency f_{SW} of the signal at the pin SW is also stabilized at the reference frequency f_{REF}.

The input voltage V_{IN} drops at the timing to. In response to the drop in the input voltage V_{IN}, an operation timing of the circuit is changed, and the voltage level of the control signal V_{CTRL} for keeping that switching frequency f_{SW} at the reference frequency f_{REF} is changed. However, the frequency stabilizing circuit 240 includes a low-pass filter containing a response delay, and so the control signal V_{CTRL} is delayed with respect to the change in the input voltage V_{IN}. As a result, shortly after the timing to, the switching frequency f_{SW} temporarily rises, and then if the control signal V_{CTRL} is optimized by means of feedback control, the switching frequency f_{SW} gradually approximates the reference frequency f_{REF}.

The input voltage V_{IN} rises at the timing t₁. In response to the rise in the input voltage V_{IN}, an operation timing of the circuit is changed. Since the control signal V_{CTRL} is changed with respect to the change in the input voltage V_{IN}, the switching frequency f_{SW} temporarily drops shortly after the timing t₁, and then if the control signal V_{CTRL} is optimized by means of feedback control, the switching frequency f_{SW} gradually approximates the reference frequency f_{REF}.

As such, in the comparison technique, for the fluctuation in the input voltage V_{IN}, the frequency is stabilized with the feedback control intervened by the low-pass filer, and a frequency fluctuation that cannot be overlooked is generated due to the response delay.

The DC/DC converter 100 of the embodiment is further described. FIG. 5 shows a waveform diagram of the operation of the DC/DC converter 100 according to the embodiment. In the DC/DC converter 100 of the embodiment, for the fluctuation in the input voltage V_{IN}, feedforward control can be performed on the slope of the slope voltage V_{C2} of the capacitor C2 with respect to each switching cycle. The feedforward control does not involve any intervention of a low-pass filter, and so the response delay can be eliminated, and the switching frequency f_{SW} can then be prevented from shifting away from the reference frequency f_{REF}.

The advantage of the DC/DC converter 100 is as described above.

Various devices and methods of the disclosure related to the block diagram or circuit diagram in FIG. 1, or handling of circuit diagrams or derived from the description above are not limited to being specific configurations. To help better and more clearly understand the essentials and operations of the disclosure but not to narrow a scope of the disclosure, more specific configuration examples and embodiments are described below.

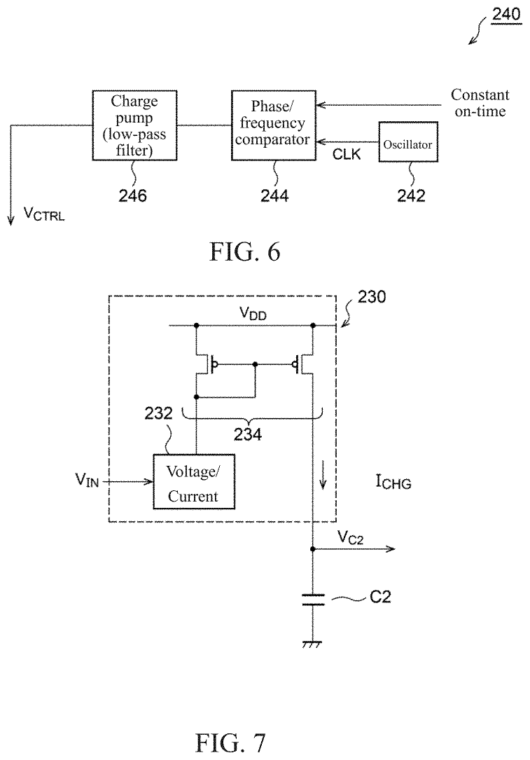

FIG. 6 shows a circuit diagram of a configuration example of the frequency stabilizing circuit 240. The frequency stabilizing circuit 240 is a phase-locked loop (PLL) circuit, and includes an oscillator 242, a phase/frequency comparator 244, and a charge pump circuit 246. The oscillator 242 generates a reference clock CLK having the reference frequency f_{REF}. The phase/frequency comparator 244 compares a signal (for example, the signal COT) having the switching frequency f_{SW} with the phase and frequency of the reference clock CLK, and generates a rise and fall signal representing a comparison result. The charge pump circuit 246 generates the control signal V_{CTRL} according to rising or falling of the rise and fall signal. The charge pump circuit 246 also provides the function of a low-pass filter. Moreover, a phase comparator may also be used in substitution for the phase/frequency comparator 244. A frequency-locked loop (FLL) circuit may also be used to form the frequency stabilizing circuit 240.

FIG. 7 shows a circuit diagram of a configuration example of the charging circuit 230. In the configuration example, the charging circuit 230 includes a V/I conversion circuit 232 and a current mirror circuit 234. The V/I conversion circuit 232 converts the input voltage V_{IN} to a proportional current. The V/I conversion circuit 232 can be understood as a variable current source that generates a current proportional to the input voltage V_{IN}. The current mirror circuit 234 causes the current generated by the V/I conversion circuit 232 to flow back and be used as the charging current Imo supplied to the capacitor C2. Moreover, when the V/I conversion circuit 232 is a current source, the current mirror circuit 234 may be omitted.

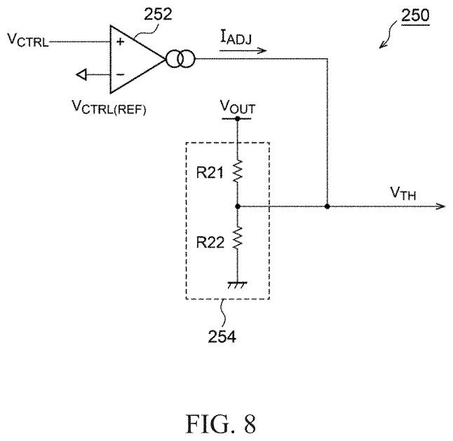

FIG. 8 shows a circuit diagram of a configuration example of the threshold voltage generating circuit 250. The threshold voltage generating circuit 250 generates the threshold voltage V_{TH} by shifting a voltage difference corresponding to the control signal V_{CTRL} by means of a voltage proportional to the output voltage V_{OUT} of the DC/DC converter 100 as a reference.

For example, the threshold voltage generating circuit 240 includes a transconductance amplifier (gm amplifier) 252 and a voltage dividing circuit 254. The voltage dividing circuit 254 includes resistors R21 and R22, and divides the output voltage V_{OUT} by a voltage dividing ratio γ, in which γ=R22/(R21+R22). An output of the gm amplifier 252 is connected to an output node of the voltage dividing circuit 254, and sources or sinks a current I_{ADJ} corresponding to a difference between the control signal V_{CTRL} and the reference voltage V_{CTRL}(REF). The threshold voltage V_{TH} generated by the threshold voltage generating circuit 250 increases or decreases by using a voltage level V_{TH0}=V_{OUT}*R22/(R21+R22) as a reference, in other words, increases or decreases according to the control signal V_{CTRL}.

The threshold voltage generating circuit 250 in FIG. 8 generates the threshold voltage V_{TH} by using the voltage level V_{TH0} corresponding to the output voltage V_{OUT} as a reference. Thus, when the output voltage V_{OUT} fluctuates, the influence of the voltage dividing circuit 254 is directly reflected to the threshold voltage V_{TH} without involving the frequency stabilizing circuit 240. That is to say, for the output voltage V_{OUT}, similar to the input voltage V_{INT}, feedforward is applied to each switching cycle. Accordingly, responsiveness can be further improved.

Moreover, the threshold voltage generating circuit 250 in FIG. 8 becomes even more beneficial in a discontinuous current mode described below.

### (Discontinuous Current Mode).

When the DC/DC converter 100 is used in an area with a smaller load current, operation is performed in a discontinuous current mode. In this case, a zero current circuit for switching between a discontinuous current mode (DCM) and a continuous current mode (CCM) is disposed in the control circuit 200.

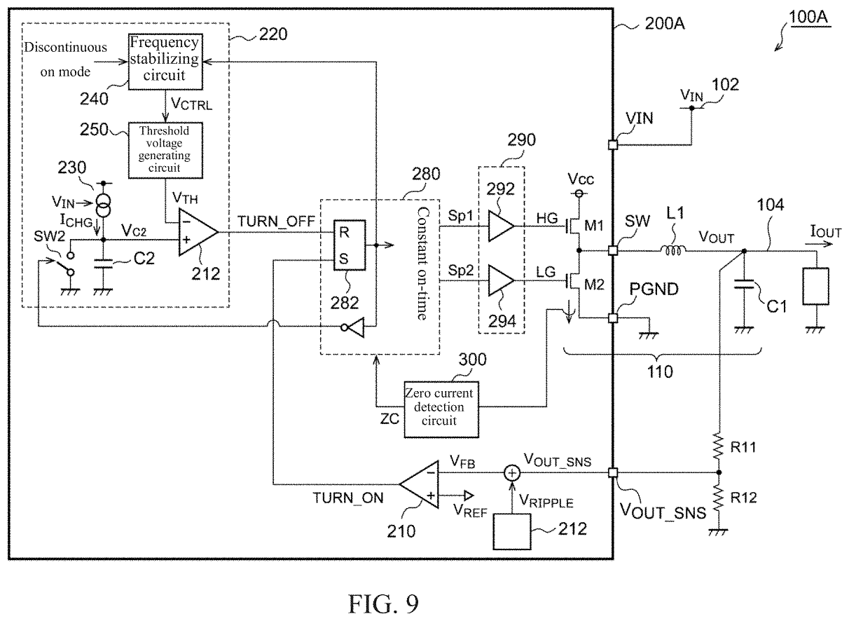

FIG. 9 shows a circuit diagram of a DC/DC converter 100A corresponding to a DCM. The DC/DC converter 100A includes a zero current detection circuit 300. The zero current detection circuit 300 monitors a current flowing to the synchronous rectifier transistor M2 in an off period in which the signal COT is at an off level, and a zero current detection signal ZC is asserted upon detecting that the current is zero (current zero-crossing).

The logic circuit 280 turns off the synchronous rectifier transistor M2 in response to the asserted zero current detection signal ZC. As a result, both the switching transistor M1 and the synchronous rectifier transistor M2 are off, and the pin SW becomes high impedance (HiZ) in a period before the switching transistor M1 is turned on.

In the control circuit 200A, the threshold voltage generating circuit 250 is configured as shown in FIG. 8.

During a period in which the DC/DC converter 100A operates in the DCM, a frequency feedback loop (frequency stabilizing control) including the frequency stabilizing circuit 240 and the threshold voltage generating circuit 250 is disabled. To disable the feedback loop, the current I_{ADJ} in FIG. 8 may be fixed to zero. For example, the control signal V_{CTRL} output by the frequency stabilizing circuit 240 may be fixed at a voltage level when the current I_{ADJ} in FIG. 8 is zero. Alternatively, once entering the DCM, the operation of the gm amplifier 252 in FIG. 8 is halted so that the current I_{ADJ} is zero.

When the current I_{ADJ} in FIG. 8 is zero, the threshold voltage V_{TH} becomes equation (6).

V_{TH}=V_{OUT}*R22/(R21/+R22)==*V_{OUT} (6)

Wherein, γ=R22/(R21+R22).

By substituting equation (6) into equation (3), equation (7) is obtained as an on time T_{ON_DCM} in the DCM.

T_{ON_DCM}=β·V_{TH}/V_{IN}=β·γ*V_{OUT}/V_{IN} (7)

The on time T_{ON_DCM} is proportional to a ratio of the input voltage V_{IN} to the output voltage V_{OUT} (voltage drop ratio), and is independent from a load current.

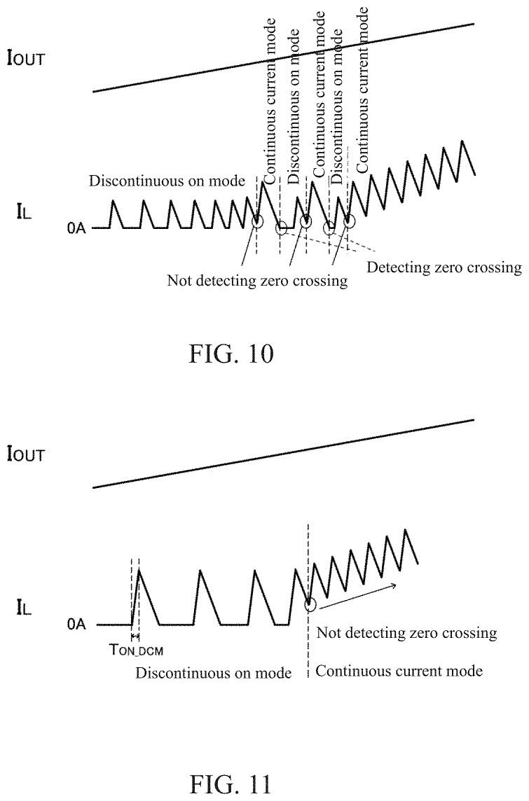

FIG. 10 shows a diagram for illustrating a CCM, a DCM and a switching operation in the control circuit 200A. For better understanding and to keep the description succinct, the input voltage V_{IN} and the output voltage V_{OUT} are fixed, and only the load current I_{OUT} fluctuates. Operations are performed in the DCM in an area with a smaller load current and in the CCM in an area with a larger load current.

In the DCM, the on time T_{ON_DCM} is expressed by equation (7), and a switching frequency f_{SW_DCM} at this point changes according to the load current I_{OUT}. Moreover, when the mode transitions from the DCM to the CCM, the frequency stabilizing control is asserted, and so the switching frequency f_{SW_DCM} is stabilized as the reference frequency f_{REF}. During the mode transition, if the switching frequency f_{SW_CCM} is higher than the reference frequency f_{REF} before shortly transitioning to the CCM, a coil current produces zero crossing shortly after the transition to the CCM and the mode returns to the DCM. According to the situation above, inter-mode oscillation between the CCM and the DCM is sometimes generated.

To inhibit the inter-mode oscillation, the relationship f_{SW_DCM}<f_{REF} needs to be established. Thus, the on time T_{ON_DCM} in the DCM needs to be longer than an ideal on time T_{ON(DEAL)}=T_{REF}*V_{OUT}/V_{IN} (to be referred to as a first switching method).

FIG. 11 shows a waveform diagram of the operation of a control circuit 200A having inhibited inter-mode oscillation. By increasing the on time T_{ON_DCM} in the DCM, the coil current I_{L} in the DCM is greater compared to that in FIG. 10. As a result, the load current I_{OUT} increases, and the current zero crossing does not occur easily after the transition to the CCM, while the inter-mode oscillation can be inhibited.

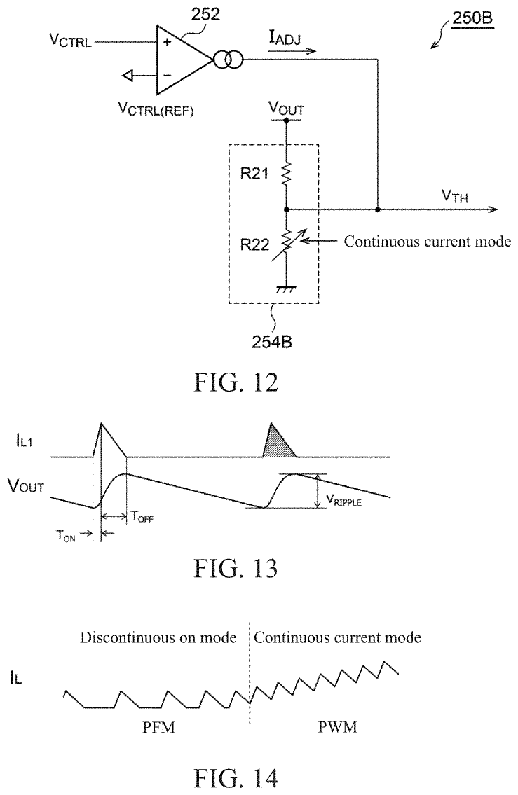

FIG. 12 shows a circuit diagram of a threshold voltage generating circuit 250B. In order for the threshold voltage generating circuit 250B to inhibit the inter-mode oscillation, the threshold voltage generating circuit 250 in FIG. 8 is modified. The threshold voltage generating circuit 250B includes the gm amplifier 252 and a voltage dividing circuit 254B. The voltage dividing circuit 254B is configured to have a variable voltage dividing ratio γ in the CCM and DCM, and a voltage dividing ratio γ_{CCM} in the CCM and a voltage dividing ratio γ_{DCM} in the DCM satisfy the equation below.

γ_{CCM}<γ_{DCM}

For example, a variable resistor may be used to form a lower-side resistor R22, so that a resistance value in the CCM is higher than a resistance value in the DCM. Conversely, a variable resistor may be used to form an upper-side resistor R21, so that a resistance value in the CCM is lower than a resistance value in the DCM.

FIG. 13 shows a diagram of a waveform of an output voltage in the DCM. A ripple voltage in the DCM gets larger as the load current I_{OUT} decreases; in a state where the load current I_{OUT} is sufficiently small, a value obtained by dividing the electric charge amount obtained by integrating the shaded part of the coil current by a capacitance value of the output capacitor can approximate a value obtained by applying the ripple voltage V_{RIPPLE}, and is expressed by equation (8).

$$\begin{matrix} [ Mathematical expression 1 ] & \\ {V}_{RIPPLE} = \frac{1}{{C}_{OUT}} {\int }_{Cycle}^{ } {I}_{L} dt = \frac{1}{{C}_{OUT}} {\int }_{0}^{{T}_{ON}} \frac{{V}_{IN} - {V}_{OUT}}{L} tdt + \frac{1}{{C}_{OUT}} {\int }_{- {T}_{OFF}}^{0} \frac{- {V}_{OUT}}{L} tdt = \frac{{V}_{IN}^{2} - {V}_{IN} {V}_{OUT}}{2 {LC}_{OUT} {V}_{OUT}} {T}_{ON}^{2} & ( 8 )\end{matrix}$$

According to equation (8), the ripple voltage V_{RIPPLE} in the DCM is proportional to the square of the on time. For example, if the on time is 1.5 times, the ripple voltage V_{RIPPLE} is 2.25 times. In the first switching method, the on time T_{ON_DCM} in the DCM is caused to be longer than the ideal on time T_{ON_(DEAL)}=T_{REF}*V_{OUT}/V_{IN}. Thus, in the operation in the DCM, a problem of increased ripples in the output voltage V_{OUT} exists. To reduce the ripple voltage V_{RIPPLE} in the DCM, a second switching method below may be used.

FIG. 14 shows a diagram for illustrating transition from the DCM to the CCM in the second switching method. In the second switching method, pulse width modulation (PWM) control is performed in the CCM. Specifically, the operation is performed at a fixed frequency by adjusting the on time by means of a PLL control.

On the other hand, pulse frequency modulation (PFM) is performed in the DCM. In the PFM control, the PLL control is deasserted, and the on time T_{ON} is set to the ideal on time T_{ON(IDEAL)}.

FIG. 14 indicates transition from a light load state to a heavy load state. The mode switches from the DCM to the CCM as the load current increases and a high-impedance (Hi) period Ma decreases. To assert the PLL control while switching to the CCM, the operation is performed by means of PWM control.

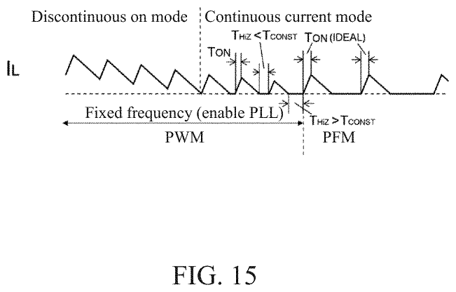

FIG. 15 shows a diagram for illustrating transition from the CCM to the DCM in the second switching method. FIG. 15 indicates transition from a heavy load state to a light load state. The mode transitions from the CCM to the DCM as the load current decreases and the coil current I_{L} reduces. In the first switching method, the PLL is deasserted synchronously with the transition to the DCM; however, in the second method, the PLL control is kept asserted. Thus, in order control the frequency to be fixed, the on time is decreased as the load current I_{OUT} decreases, and conversely, the high-impedance period T_{HiZ} increases. Moreover, the PLL control is deasserted when the high-impedance period T_{HiZ} exceeds a predetermined time length T_{CONST}. Thus, the on time T_{ON} is set to the ideal on time T_{ON(IDEAL)}. With the control above, the ripple voltage during a light load can be inhibited.

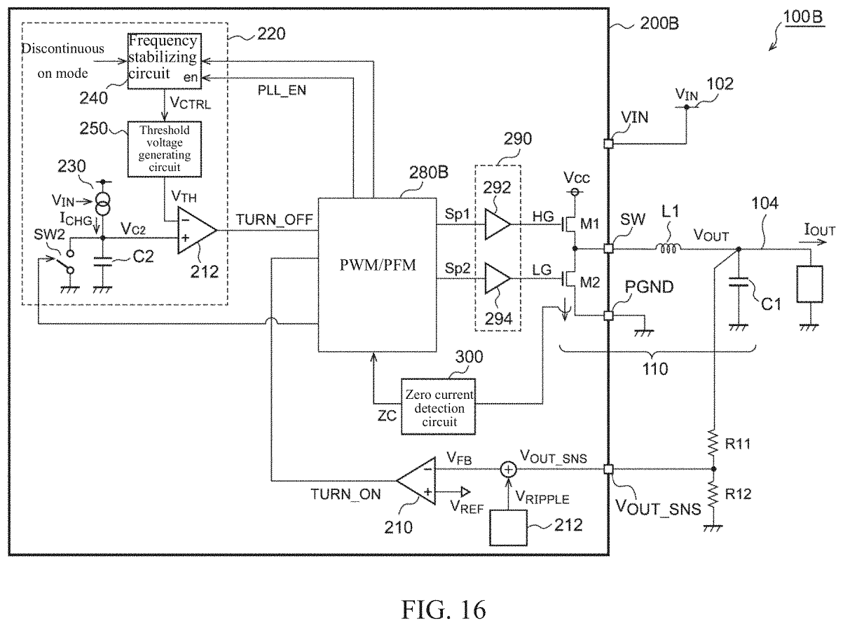

FIG. 16 shows a circuit diagram of a DC/DC converter 100B corresponding to the second switching method. Similar to the DC/DC converter 100A in FIG. 10, the DC/DC converter 100B includes a zero current detection circuit 300. The zero current detection circuit 300 monitors a current flowing to the synchronous rectifier transistor M2 in an off period in which the signal COT is at an off level, and a zero current detection signal ZC is asserted upon detecting that the current is zero (current zero-crossing).

A logic circuit 280B switches between the PWM control and FPM control based on a zero current detection signal ZC, and generates a high-side pulse Sp1 and a low-side pulse Sp2.

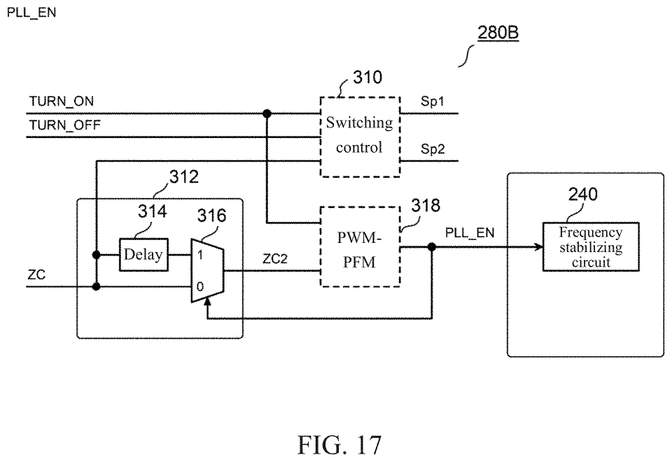

FIG. 17 shows a block diagram of a logic circuit 280B corresponding to the second switching method. The logic circuit 280B further includes a switching controller 310, a high impedance period determining portion 312, and a PWM-PFM control portion 318.

The switching controller 310 generates the high-side pulse Sp1 and the low-side pulse Sp2 based on the turn-on signal TURN_ON, the turn-off signal TURN_OFF and the zero current detection signal ZC.

The high impedance period determining portion 312 determines whether the high impedance period T_{HiZ} is longer or shorter than the predetermined time length T_{CONST}. When T_{HiZ}>T_{CONST}, a determination signal ZC2 is asserted (for example, high). For example, the high impedance period determining portion 312 includes a delay circuit 314 and a selector (multiplexer) 316. The delay circuit 314 designates a delay corresponding to predetermined time length T_{CONST} to the zero current detection signal ZC. The selector 316 receives a delayed zero current detection signal ZCd and the delayed zero current detection signal ZC before the delay, selects the delayed zero current detection signal ZCd during the PWM control, selects the zero current detection signal ZC during the PFM control, and uses and outputs the selected signal as the determination signal ZC2.

The PWM-PFM control portion 318 sets a PLL_EN signal to low when the determination signal ZC2 is asserted so as to disable the frequency stabilizing circuit 240. Thus, the PFM control is performed.

The PWM-PFM control portion 318 sets a PLL_EN signal to high when the determination signal ZC2 is disabled so as to enable the frequency stabilizing circuit 240. Thus, the PWM control is performed.

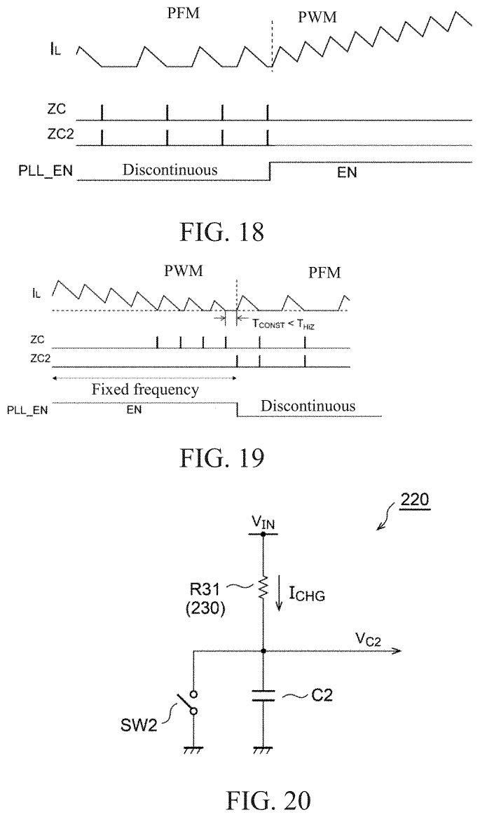

FIG. 18 shows a waveform diagram of the operation of the logic circuit 280B in FIG. 17 transitioning from the DCM to the CCM.

First, the operation is performed with the PFM control in a light load state. As the load current increases and the high impedance (HiZ) period T_{HiZ} decreases, the zero current detection signal ZC is no longer asserted and the mode transitions to the CCM when a peak value of the coil current I_{L} is greater than zero. When the zero current detection signal ZC is no longer asserted, the determination signal ZC2 is similarly no longer asserted, and so the PLL_EN signal becomes high, the frequency stabilizing circuit 240 is enabled, and transition to the PWM control takes place.

FIG. 19 shows a waveform diagram of the operation of the logic circuit 280B in FIG. 17 transitioning from the CCM to the DCM. First, the operation is performed with the PWM control in a heavy load state. As the load current reduces, the coil current I_{L} decreases, and the peak value of the coil current I_{L} drops to zero, the mode transitions to the DCM. Immediately after the transition to the DCM, since T_{HiZ}<T_{CONST}, the determination signal ZC2 is not asserted, and the signal PLL_EN is kept at high. Thus, in a short period, the PLL control is asserted, the switching frequency is kept constant, the on time is decreased as the load current I_{OUT} decreases, and conversely, the high-impedance period T_{HiZ} increases. Moreover, the determination signal ZC2 is asserted when the high-impedance period T_{HiZ} exceeds the predetermined time length T_{CONST}. As a result, the signal PLL_EN becomes low, and the PLL control is disabled. When the PLL control is disabled, the on time T_{ON} is set to the ideal on time T_{ON(IDEAL)}. With the control above, the ripple voltage during a light load can be inhibited.

Details of the embodiments of the disclosure are described as above. It should be understood that, the embodiments are exemplary, and various modifications may be made to combinations of the constituting elements and processes, and such modifications are to be encompassed within the scope of the disclosure. Details of such variation examples are given in the description below.

### Variation Examples 1

FIG. 20 shows a circuit diagram of a part of the on-time generating circuit 20 of a first variation example. The charging circuit 230 includes a resistor R31 having a first end that receives the input voltage V_{IN} and a second end that is connected to the capacitor C2.

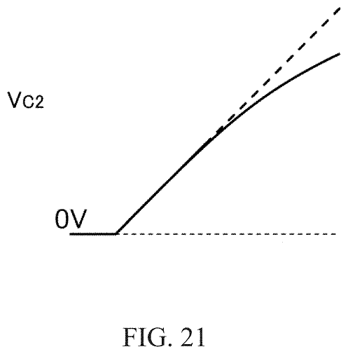

FIG. 21 shows a diagram of the slope voltage V_{C2} generated in the on-time generating circuit 220 in FIG. 20. In an area where the voltage level is lower, the slope voltage V_{C2} linearly increases with time, and the charging circuit 230 in FIG. 7 can be replaced according to a criterion of defining an area in which the threshold voltage V_{TH} is considered to be linear. The charging circuit 230 in FIG. 20 can be formed by one resistor, and thus the circuit area is reduced compared to the charging circuit 230 in FIG. 7.

### Variation Examples 2

To inhibit inter-mode oscillation, the voltage dividing ratio γ for switching the threshold voltage generating circuit 250 can be replaced; alternatively, the gain α of the charging circuit 230 is switched in the DCM and the CCM. Specifically, a gain α_{CCM} in the CMM and a gain αγ_{DCM} in the DCM can also satisfy the equation below.

α_{CCM}>α_{DCM}

Accordingly, the charging speed of the capacitor C2 in the DCM becomes slow, and so the on time T_{ON_DCM} can be increased.

### Variation Examples 3

Moreover, in order to inhibit inter-mode oscillation, a capacitance value of the capacitor C2 may be variable. Specifically, a capacitance C_{CCM} in the CCM and a capacitance Cγ_{DCM} in the DCM can also satisfy the equation below.

C_{CCM}<C_{DCM}

Accordingly, the slope of the slope voltage V_{C2} generated at the capacitor C2 in the DCM becomes smaller, and so the on time T_{ON_DCM} can be increased.

### Variation Examples 4

In the embodiment, the turn-on signal TURN_ON is generated by the same first comparator 210 in the DCM and the CCM, or different comparators may be used in the DCM and the CCM.

### Variation Examples 5

In FIG. 8, the output voltage V_{OU}T is, for example but not limited to, input to the voltage dividing circuit 254, or a voltage equivalent to the target voltage V_{OUT(REF)} of the output voltage V_{OUT} may also be input.

### Variation Examples 6

In the embodiment, the switching transistor M1 and the synchronous rectifier transistor M2 are, for example but not limited to, integrated in the control circuit 200, or the switching transistor M1 and the synchronous rectifier transistor M2 may also be discrete elements provided externally. Moreover, the synchronous rectifier transistor M2 may be an N-channel metal-oxide-semiconductor field-effect transistor (MOSFET), and in this case, a bootstrap circuit is added to the high-side driver 292.

### (Use)

The DC/DC converter 100 or the control circuit 200 may be used in, for example but not limited to, a power management integrated circuit.

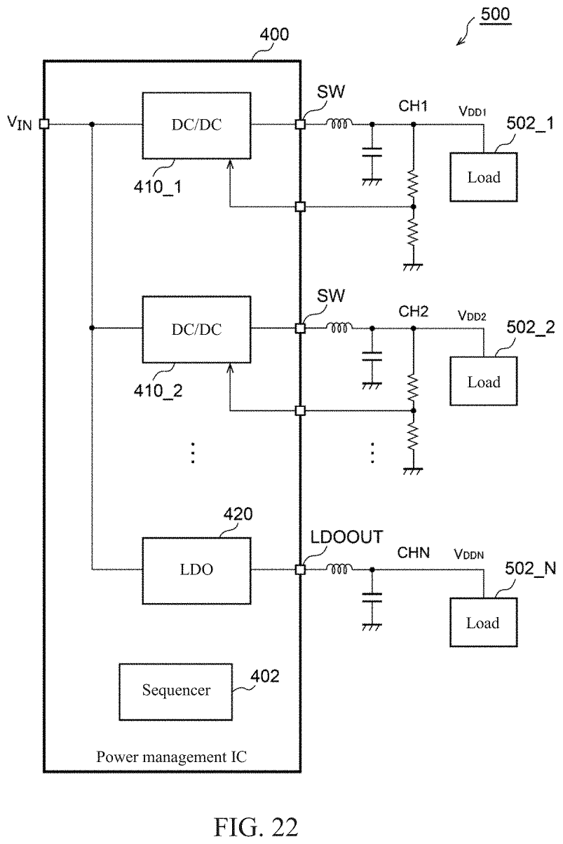

FIG. 22 shows a block diagram of a system 500 with a power management integrated circuit 400. The system 500 includes the power management integrated circuit 400 and N (N≥2) loads 502_1 to 502_N. The power management integrated circuit 400 and peripheral circuits externally provided jointly form a power circuit of a plurality of channels CH1 to CHN, and power voltages V_{DD1} to V_{DDN} with appropriate voltage level are applied to the plurality of loads 502_1 to 502_N. Some of the plurality of channels (in this example, CH1 and CH2) are buck converters, and the control circuits 410_1 and 410_2 thereof are formed by the structure of the control circuit 200. The remaining channels are formed by low drop output (LDO) circuits 420. A sequencer 402 controls on sequences, off sequences and timings of the power circuits of the plurality of channels.

The system 500 is not specifically defined, and may be, for example, a storage device such as a solid-state drive (SSD) used in data centers. Alternatively, the system 500 may be an on-vehicle audiovisual device, a laptop/desktop computer, a server, or may also be an electronic device such as a smartphone, a tablet computer or an audio player.

1. A control circuit of a DC/DC converter including a switching transistor, the control circuit comprising:
a first comparator comparing a feedback voltage corresponding to an output voltage of the DC/DC converter with a reference voltage to assert a turn-on signal when the feedback voltage falls below the reference voltage;
an on-time generating circuit asserting a turn-off signal after an on time has elapsed from a turning on of the switching transistor;
a logic circuit generating a pulse signal based on the turn-on signal and the turn-off signal; and
a driver driving the switching transistor according to the pulse signal, wherein the on-time generating circuit includes:
a capacitor;
a charging circuit charging the capacitor with a charging current corresponding to an input voltage of the DC/DC converter;
a frequency stabilizing circuit generating a control signal such that a switching frequency of the switching transistor approximates to a reference frequency;
a threshold voltage generating circuit generating a threshold voltage corresponding to the control signal; and
a second comparator comparing a slope voltage generated in the capacitor with the threshold voltage and generating the turn-off signal according to a comparison result.

2. The control circuit of claim 1, wherein the threshold voltage generating circuit generates the threshold voltage by shifting a voltage difference corresponding to the control signal by means of a voltage proportional to the output voltage of the DC/DC converter as a reference.

3. The control circuit of claim 2, wherein the frequency stabilizing circuit includes:
a voltage dividing circuit dividing the output voltage of the DC/DC converter; and
a current source connected to an output node of the voltage dividing circuit and generating a current corresponding to the control signal, wherein
a voltage generated at the output node of the voltage dividing circuit is the threshold voltage.

4. The control circuit of claim 3, where the current source is a gm amplifier that generates a current corresponding to a difference between the control signal and a predetermined voltage.

5. The control circuit of claim 1, wherein the charging circuit includes a variable current source that produces a current proportional to the input voltage.

6. The control circuit of claim 2, wherein the charging circuit includes a variable current source that produces a current proportional to the input voltage.

7. The control circuit of claim 3, wherein the charging circuit includes a variable current source that produces a current proportional to the input voltage.

8. The control circuit of claim 1, wherein the charging circuit includes a resistor including a first end that receives the input voltage and a second end that is connected to the capacitor.

9. The control circuit of claim 2, wherein the charging circuit includes a resistor including a first end that receives the input voltage and a second end that is connected to the capacitor.

10. The control circuit of claim 3, wherein the charging circuit includes a resistor including a first end that receives the input voltage and a second end that is connected to the capacitor.

11. The control circuit of claim 1, wherein the frequency stabilizing circuit is disabled when the DC/DC converter operates in a current discontinuous mode.

12. The control circuit of claim 2, wherein the frequency stabilizing circuit is disabled when the DC/DC converter operates in a current discontinuous mode.

13. The control circuit of claim 1, wherein when the DC/DC converter shifts from a current continuous mode to a current discontinuous mode, the frequency stabilizing circuit is invalid provided that a length of a high impedance period exceeds a predetermined period.

14. The control circuit of claim 2, wherein when the DC/DC converter shifts from a current continuous mode to a current discontinuous mode, the frequency stabilizing circuit is invalid provided that a length of a high impedance period exceeds a predetermined period.

15. The control circuit of claim 3, wherein when the DC/DC converter operates in a current discontinuous mode, a current of the current source becomes zero.

16. The control circuit of claim 1, wherein when the reference frequency is f_{REF}, the input voltage of the DC/DC converter is V_{IN}, and the output voltage is V_{OUT}, an on-time TON_DCM in the on-time generating circuit when the DC/DC converter operates in a current discontinuous mode satisfies:
TON_DCM>1/f_{REF}×V_{OUT}/V_{IN}.

17. The control circuit of claim 3, wherein a voltage dividing ratio of the voltage dividing circuit is greater when the DC/DC converter operates in a current discontinuous mode than in a current continuous mode.

18. The control circuit of claim 1, wherein control circuit is integrated on a semiconductor substrate.

19. A power management circuit, comprising the control circuit of claim 1.

20. A control method of a control circuit of a DC/DC converter including a switching transistor, the method comprising:
comparing a feedback voltage corresponding to an output voltage of the DC/DC converter with a reference voltage, and asserting a turn-on signal when the feedback voltage falls below the reference voltage;
asserting a turn-off signal after an on time has elapsed since the switching transistor was turned on;
generating a pulse signal based on the turn-on signal and the turn-off signal; and
driving the switching transistor according to the pulse signal, wherein the step of asserting the turn-off signal includes:
charging a capacitor with a charging current corresponding to an input voltage of the DC/DC converter;
generating a control signal such that a switching frequency of the switching transistor approaches a reference frequency;
comparing a slope voltage generated in the capacitor with the threshold voltage corresponding to the control signal; and
generating the turn-off signal according to a comparison result.
